(19) United States
(12) Patent Application Publication
(10) Pub. No.: US 2020/0369334 A1
(43) Pub. Date: Nov. 26, 2020

(54) MODULAR ELECTRIC TRUCK SYSTEM

(71) Applicant: Edward Lee, Costa Mesa, CA (US)

(72) Inventor: Edward Lee, Costa Mesa, CA (US)

(21) Appl. No.: 16/421,345

(22) Filed: May 23, 2019

(51) Int. Cl. B62D 65/02; B60L 8/00; B62D 65/14; B60K 7/00

(52) U.S. Cl. CPC B62D 65/024; B60L 8/003; B62D 53/06; B60K 7/0007; B62D 65/14

(57) ABSTRACT

A modular electric truck system provides an electric truck that has a scalable chassis that can be equipped with interchangeable modular body components that detachably attach to the truck chassis to change the appearance and functionality of the electric truck. An interior cabin comprises furniture, lighting elements, computer devices, and entertainment systems. The driver sits in a center driving position where visibility and positional awareness is enhanced. The electric truck is 100% electrical; and thereby provides convenient electrical charging means for the truck through a charging trailer that attaches to the truck, and/or at least one solar panel on the roof, bed, or trailer of the truck. The solar panel charges a battery that operatively connects to a hub motor in the wheels. A remote control system remotely controls at least one trailer. The trailer may be tethered, wireless, or autonomous to wirelessly track and follow the truck.

### FIELD OF THE INVENTION

The present invention relates generally to a modular electric truck system. More so, the present invention relates to an electric truck that can be modified with interchangeable modular body components that easily attach and detach to the truck chassis; and further provides photovoltaic solar panel that charges the battery of the truck for operation of hub motors in the wheels; and further provides a charging trailer that tethers, or wirelessly tracks and follows the electric truck; and further provides an interior cabin having customizable space in which a passenger customizes and integrates desired furniture, lighting elements, computer devices, technology, connectivity, and entertainment systems; and further a center driving position for increased visibility and non-biased awareness of truck position.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, an electric vehicle operates solely on battery power and does not use an internal combustion engine alone or in combination with a battery to form a hybrid system. Often, a communication interface system is included in the electric vehicle to provide a complete plug since the electric vehicle relies exclusively on battery power to propel the vehicle is needed.

The rechargeable batteries that supply driving power to the electric vehicle form a considerable amount of the space and weight of the total vehicular weight and bulk, thereby restricting transport capacity of the vehicle which would be otherwise left available. Also, it is known in the art that the cattery capacity determines the driving range of the vehicle. Further, in recharging drained batteries, it becomes obligatory that the electric vehicle be rendered immobile for several hours on the average. This traditionally requires a stationary charging point, which may not always be available.

Other proposals have involved electrical vehicles. The problem with these vehicles is that they do not reconfigure to carry large amounts of people or loads. Also, they do not have an attachable trailer that performs multiple functions. Even though the above cited electrical vehicles meet some of the needs of the market, a modular electric truck system that can be modified with interchangeable modular body components that easily attach and detach to the truck chassis; and further provides photovoltaic solar panel that charges the battery of the truck for operation of hub motors in the wheels; and further provides a charging trailer that tethers, or wirelessly tracks and follows the electric truck; and further provides an interior cabin having customizable space in which a passenger customizes and integrates desired furniture, lighting elements, computer devices, technology, connectivity, and entertainment systems; and further a center driving position for increased visibility and non-biased awareness of truck position, is still desired.

### SUMMARY

Illustrative embodiments of the disclosure are generally directed to a modular electric truck system. The electric truck system is uniquely modular in that the truck has a scalable chassis that can be equipped with interchangeable body components that easily attach and detach to the rear of the truck chassis to change the appearance and functionality of the electric truck. For example, the truck has an interchangeable roof, a van shell, and a truck bed shell. In another embodiment, the truck can be converted to a van, and/or have an attachable extended rear storage compartment, and an additional set of wheels for off-road performance.

The electric truck system is 100% electrical, using at least one photovoltaic solar panel to convert solar energy to electricity that charges a battery for powering at least one hub motor in the wheels of the electric truck. Further, the system provides convenient electrical charging means for the truck through a charging trailer that attaches to the truck, and/or at least one solar panel on the roof, bed, or trailer of the truck. The system may utilize regenerative braking to decelerate.

The system provides a remote control system that also allows the truck to remotely control at least one trailer. This may include an autonomous trailer and/or a remote multi-haul system. In this manner, the driver, passenger, or a remote user can control the trailer to wirelessly track and follow the truck. The trailer may be motorized or non-motorized.

In some embodiments, the truck has a unique interior cabin that is designed to be a customizable space, similar to a home interior. The interior cabin comprises walls, floors, ceiling and open space in which a passenger customizes and integrates desired furniture, lighting elements, computer devices, technology, connectivity, and entertainment systems. In the interior cabin, the driver sits in a center driving position. The center driving position is characterized by a central position of the cabin where driving visibility and non-biased awareness of truck position is enhanced.

In one aspect, the modular electric truck system, comprises:
a chassis comprising a front portion defined by an interior cabin, a rear portion defined by an open truck bed, and a roof,
the interior cabin comprising a steering member operatively connected to the front wheels, an illumination portion, at least one seat, at least one communication interface, and a computer having a software program;
at least one modular body component detachably attachable to the open truck bed of the chassis;
a pair of steerable front wheels supporting the front portion of the chassis;
at least two laterally spaced rear wheels supporting the rear portion of the chassis;
at least one hub motor operational with at least one of the wheels, each hub motor operational to drive a respective wheel;
a battery operatively connected to the hub motor;
at least one trailer operatively connected to the chassis;
a remote control system disposed in the interior cabin, the remote control system being operable to wirelessly control operation of the trailer, whereby the remote control system enables the trailer to track and follow the chassis;
at least one photovoltaic solar panel disposed on the roof, or the open truck bed, or the trailer, the photovoltaic solar panel being operatively connected to the battery for recharging the battery; and
whereby the software program is operational to control at least one of the following: the remote control system, the illumination portion, the battery, and the hub motor.

In another aspect, the system further comprises a trailer operatively attached to the chassis, the trailer comprising the at least one solar panel.

In another aspect, the trailer is wirelessly attached to the chassis.

In another aspect, the software program enables autonomous control of the trailer.

In another aspect, the modular body component comprises a van shell.

In another aspect, the modular body component comprises a truck bed shell and multiple interchangeable roofs having different sizes.

In another aspect, the system further comprises at least one additional wheel attached to the rear portion of the chassis.

In another aspect, the hub motor is encompassed inside at least one of the wheels.

In another aspect, the system further comprises a regenerative electric braking circuit.

In another aspect, the remote control system comprises a transceiver in operational connectivity with the software program, the transceiver being operable to send and receive radio frequency signals, including messages, location data, information requests, and control codes.

In another aspect, the trailer autonomously tracks and follows the chassis.

In another aspect, the electric braking circuit is operatively connected to the hub motor, whereby the electric braking circuit causes electric braking of the wheels, whereby the hub motor generates a back electromotive force that feeds the battery.

One objective of the present invention is to create a clean energy truck with zero emissions.

Another objective is to provide a modular electric truck with interchangeable body components.

Another objective is to power the truck with solar panels on the roof and on a connected trailer.

Yet another objective is to allow the driver to sit in a central position in the cabin, so as to have a better view.

Yet another objective is to allow the cabin to be customizable, similar to a home interior.

Yet another objective is to allow the driver to control a trailer remotely through an autonomous trailer and a remote multi-haul system.

Yet another objective is to provide an interchangeable rear structure with an open storage bed that can be changed to a van, a closed bed, and additional wheels.

Yet another objective is to provide an inexpensive to manufacture electric truck.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary modular electric truck system, in accordance with an embodiment of the present invention;

FIG. 2 illustrates a top view of an exemplary interior cabin of the electric truck, in accordance with an embodiment of the present invention;

FIG. 3 illustrates a left side perspective view of the interior cabin of the electric truck, in accordance with an embodiment of the present invention;

FIG. 4 illustrates a right side perspective view of the interior cabin of the electric truck, in accordance with an embodiment of the present invention;

FIG. 5 illustrates a side view of an electric truck with a van shell modular body component, in accordance with an embodiment of the present invention;

FIG. 6 illustrates a side view of an electric truck with a truck bed shell modular body component, in accordance with an embodiment of the present invention;

FIG. 7 illustrates a side view of an electric truck with an extended truck bed shell modular body component, in accordance with an embodiment of the present invention;

FIG. 8 illustrates a side view of an electric truck with exemplary photovoltaic solar panels on the roof and open truck bed, in accordance with an embodiment of the present invention;

FIG. 9 illustrates a side view of an electric truck with exemplary photovoltaic solar panels on the roof truck shell, in accordance with an embodiment of the present invention;

FIG. 10 illustrates a side view of an exemplary charging trailer with exemplary photovoltaic solar panels on the roof, in accordance with an embodiment of the present invention;

FIG. 11 illustrates a side view of an exemplary tethered trailer being pulled by the electric truck, in accordance with an embodiment of the present invention;

FIG. 12 illustrates a side view of an exemplary wireless trailer tracking and following the electric truck through a remote control system, in accordance with an embodiment of the present invention;

FIG. 13 illustrates a side view of multiple exemplary autonomous trailers tracking and following the electric truck while controlled by a software program, in accordance with an embodiment of the present invention;

FIGS. 14A-14C illustrate side views of the modular electric truck system in a base model, without trailers tracking, where FIG. 14A shows a base vehicle with a truck bed, FIG. 14B shows a base vehicle with the truck bed removed to reveal a lower rear mounting bed, and FIG. 14C shows the base vehicle with the rear cabin, roof, and mounting bed interchanged, so that the lower mounting bed is extendable without a wheelbase extension, in accordance with an embodiment of the present invention;

FIGS. 15A-15C illustrate side views of the modular electric truck system for a semi-truck configuration of the base model, where FIG. 15A shows a removable truck bed with pickup to semi conversion, FIG. 15B shows the truck bed with extended bed, and FIG. 15C shows the base vehicle with a detachable rear compartment that is motorized and operable autonomously, so that the lower mounting bed is extendable without a wheelbase extension, in accordance with an embodiment of the present invention;

FIGS. 16A-16C illustrate sides view of the modular electric truck system for a semi-truck, where FIG. 16A shows a semi-truck conversion with interchangeable and attachable open container rear compartment, FIG. 16B shows an elongated version of the interchangeable and attachable open container rear compartment, and FIG. 16C shows the semi-truck conversion with interchangeable and attachable open container rear compartment and an additional detachable rear compartment that is motorized and operable autonomously, in accordance with an embodiment of the present invention;

FIGS. 17A-17C illustrate side views of the modular electric truck system for a semi-truck, where FIG. 17A shows a semi-truck conversion with interchangeable and attachable sealed container rear compartment, FIG. 17B shows an elongated version of the interchangeable and attachable sealed container rear compartment, and FIG. 17C shows the semi-truck conversion with interchangeable and attachable sealed container rear compartment and an additional detachable sealed rear compartment that is motorized and operable autonomously, in accordance with an embodiment of the present invention; and

FIGS. 18A-18C illustrate side views of the modular electric truck system for a semi-truck, where FIG. 18A shows a semi-truck conversion with interchangeable and attachable container box rear compartment, FIG. 18B shows an elongated version of the interchangeable and attachable container box rear compartment, and FIG. 18C shows the semi-truck conversion with interchangeable and attachable container box rear compartment and an additional detachable rear compartment that is motorized and operable autonomously, in accordance with an embodiment of the present invention.

Like reference numerals refer to like parts throughout the various views of the drawings.

### DETAILED DESCRIPTION OF THE INVENTION

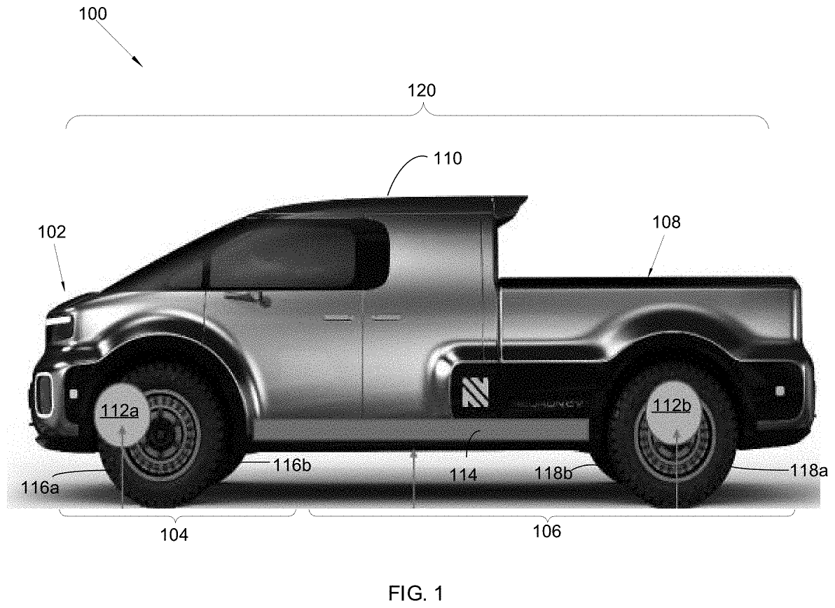

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

A modular electric truck system 100 is referenced in FIGS. 1-18C. The modular electric truck system 100, hereafter “system 100” provides an electric truck 120 that is powered by at least one photovoltaic solar panel 800a-d, and has a reconfigurable body chassis 102 that can adapt to receive interchangeable modular body components 500a-c. At least one trailer 1000a-g operatively attaches to the electric truck for tethered connectivity, or remote control tracking and following; or autonomous tracking and following to the electric truck chassis 120.

As referenced in FIG. 1, the electric truck 120 includes a chassis 102, such as those used with a truck, van, or semi-truck. The chassis 102 forms the base frame of the truck. The exterior and interior layout, structure, architecture is modifiable. The chassis 102 is created to be scalable in order to easily modify the structure to create different shapes, sizes, and types of vehicles as well as integrate various powertrain systems, charging methods, and technology, referred to as “NSC=Neuron Scalable Chassis” or “SC=Scalable Chassis” or “NC=Neuron Chassis” or “SP=Scalable Platform”.

In one embodiment, the chassis 102 is defined by rounded rectangular and or square shapes and or structures represented by 4 sides connected by 4 rounded corners. This shape is unique because the electric truck is referred to as (Squargle or SQR) used as architecture, structure, or function in automotive applications. The Squargle is a structure that can be used but not limited to a lighting architecture (SLA=Squargle Light Architecture) throughout the vehicle. The rounded rectangle is a shape that represents electric truck.

The electric truck is unique because the identity of neuron is a cell symbolized by the Squargle an enclosed entity created with four structures (flat sides) connected by 4 joints (rounded corners). Therefore the Squargle in essence is the representation of the electric truck, which in essence is an automotive cell that conducts change in the transportation industry.

Further, the system 100 integrates various attachments, interchanging architectures, and structural modularity to expand functionality while driving, stationary utility, technology, performance, passenger load capacity, storage capacity, and overall vehicle capability. In one embodiment, the pickup truck converts to a sports utility vehicle (SUV) by removing, or covering the truck open bed with a shell (See FIGS. 6 and 7, for example). The SUV configuration provides additional coverage for the interior cabin, and also includes additional seats for added passenger capacity. The SUV configuration is similar to the van configuration described below.

For example, the electric truck 120 comprises a scalable chassis 102 that can be equipped with multiple interchangeable body components 500a-c that easily attach and detach to a rear portion 106 of the truck chassis 102 to change the appearance and functionality of the electric truck 120. In one embodiment, the chassis 102 comprises a front portion 104 oriented towards the forward motion of the electric truck 120. The front portion 104 is defined by an interior cabin 200.

The chassis 102 also comprises a rear portion 106 juxtaposition to the front portion 104. The rear portion 106 is defined by an open truck bed 108, and a roof 110. The enclosed rear truck bed space provides additional seating for up to 6 passengers. The roof 110 of this enclosed shape may house a photovoltaic solar panel 800b for charging vehicle battery 114 simultaneous while driving or stationary in parked position. The rear open bed is capable to haul an additional trailer or any storage structure with wheels. Such a multi-task rear open bed changes the purpose and function of the electric truck 120, allowing for multiple task, such as: sanitation, postal delivery, delivery of service and goods, cargo transport, mobile home, and food service.

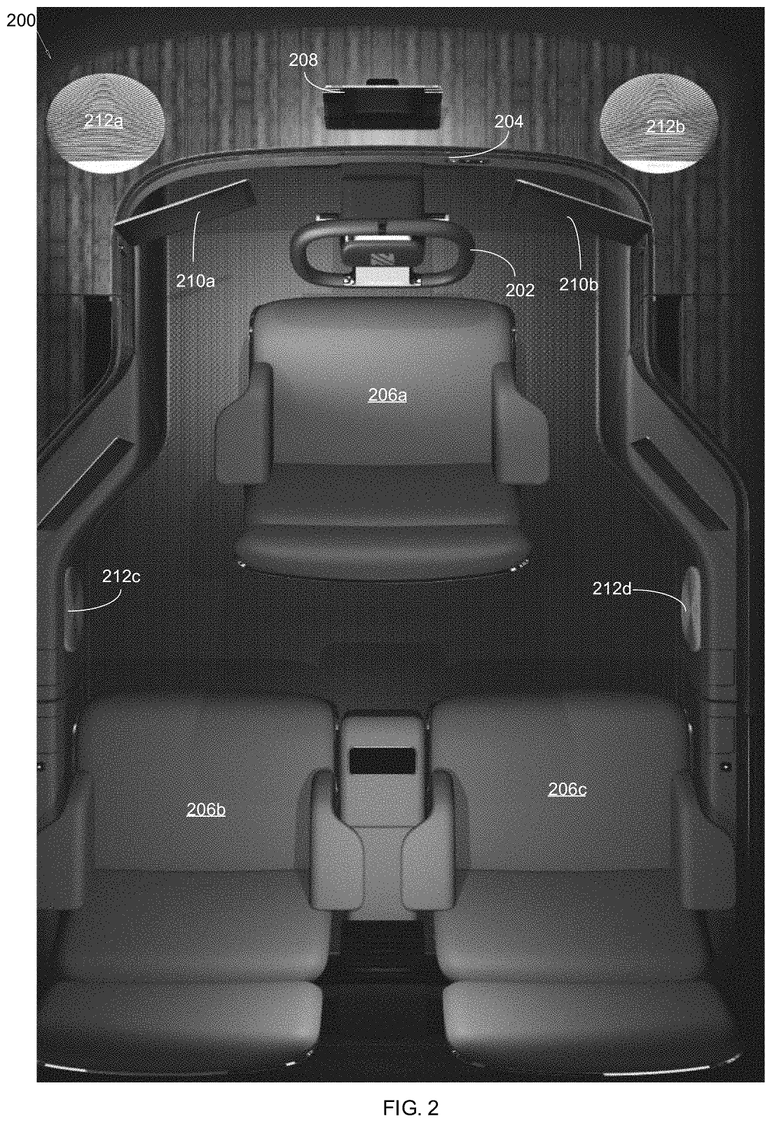

Looking now at FIG. 2, the front portion 104 of the chassis 102 is defined by an interior cabin 200 in which the driver and passenger sits on at least one seat 206a-c. The driver sits in a center driving position in a front seat 206a of the interior cabin 200. The center driving position is characterized by the driver sitting in a central position of the interior cabin, for increased visibility and non-biased awareness of truck position. The passengers sit in a left side seat 206b and a right side seat 206c behind the driver.

The interior cabin 200 also include a steering member 202 operatively connected to the front wheels 116a, 116b for steering thereof. Multiple rear wheels 118a, 118b sit behind the front wheels 116-b. The interior cabin 200 also includes an illumination portion 204 that lights up the dashboard. In one embodiment, the illumination portion 204 comprises a horizontal lighting architecture. The horizontal beam of light may be referred to as “The Horizon” or “Neuron Horizon” which is the light source that harmonizes the lower and upper body while creating a strong foundation of stability. In other embodiments, a radio and a speaker system 100 212a, 212b, 212c, 212d may also be available in the interior cabin 200 for entertainment.

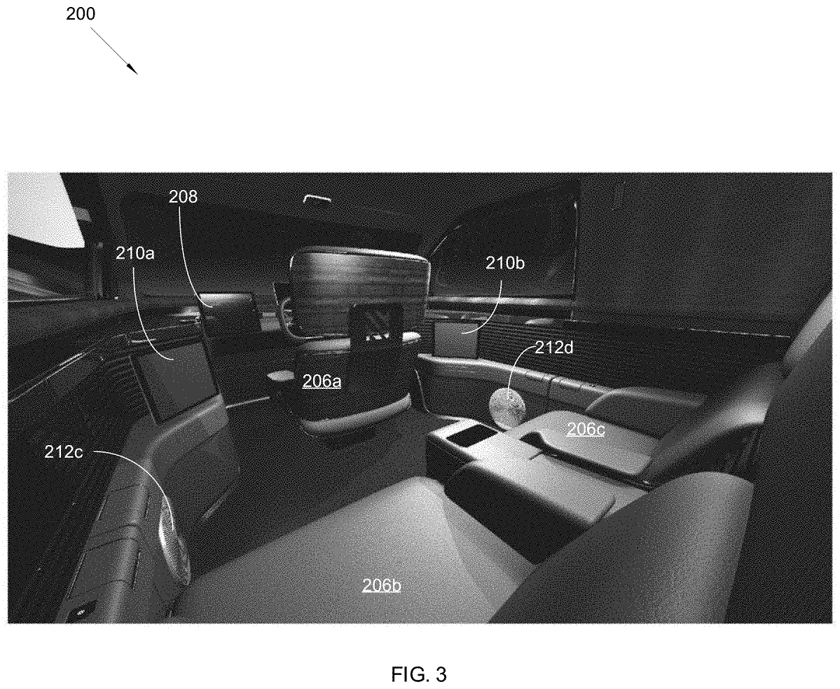

As shown in FIG. 3, the interior cabin 200 also includes at least one communication interface 210a, 210b, and a computer 208 having a software program in the interior cabin allow the driver and passenger to have further control of the components and communications of the system 100. The communication interface may be a touch screen that allows the driver to control aspects of the electric truck, such as remote control, braking capacity, entertainment, and other driving related functions.

Additionally, the electric truck 200 is unique with a cab forward design, further characterized by a continuous cabin profile defined by a short hood length, raked front windshield. This unique configuration creates a harmonized hood to cabin profile. Furthermore, the driver position is near or above front wheel axle allowing for increased rear passenger and rear storage space.

In one possible embodiment of the system 100, the interior cabin 200 is defined by a driving space that can be used as a mobile habitat such as the Truck Series, Pickup Truck, Light to Medium Duty Truck, Semi Truck with sleeper cabin and Mobile Lounges. The interior cabin may include a sleeper cabin referred to as “Mobilized Dwelling” or “Mobile Loft” or “Vehicle Loft” or “Dynamic Sleeper”. The sleeping cabin is unique because the space provided is customizable similar to a hotel room or studio apartment described as “CVI=Customizable Vehicle Interior”, where the driver and passengers are able to openly customize the vehicle interior space.

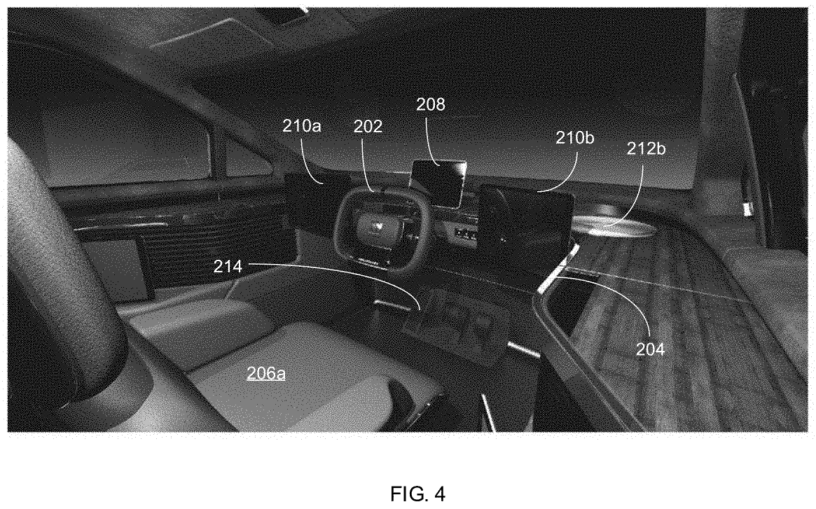

Thus, as shown in the right side rear view of FIG. 4, the driver and passenger are provided with a quiet and comfortable living space with tools to accommodate long hours of driving. Due to the fact that the interior cabin 200 is designed to be like a home, the space is specifically able to integrate any additional technology that the user desires which includes but not limited to mobile phones, tablet, computer 208, internet, entertainment system. Such an interior cabin contributes positively to humanity through automotive innovation by mobilizing the flexibility and convenience that is not provided in present combustion or electric vehicles.

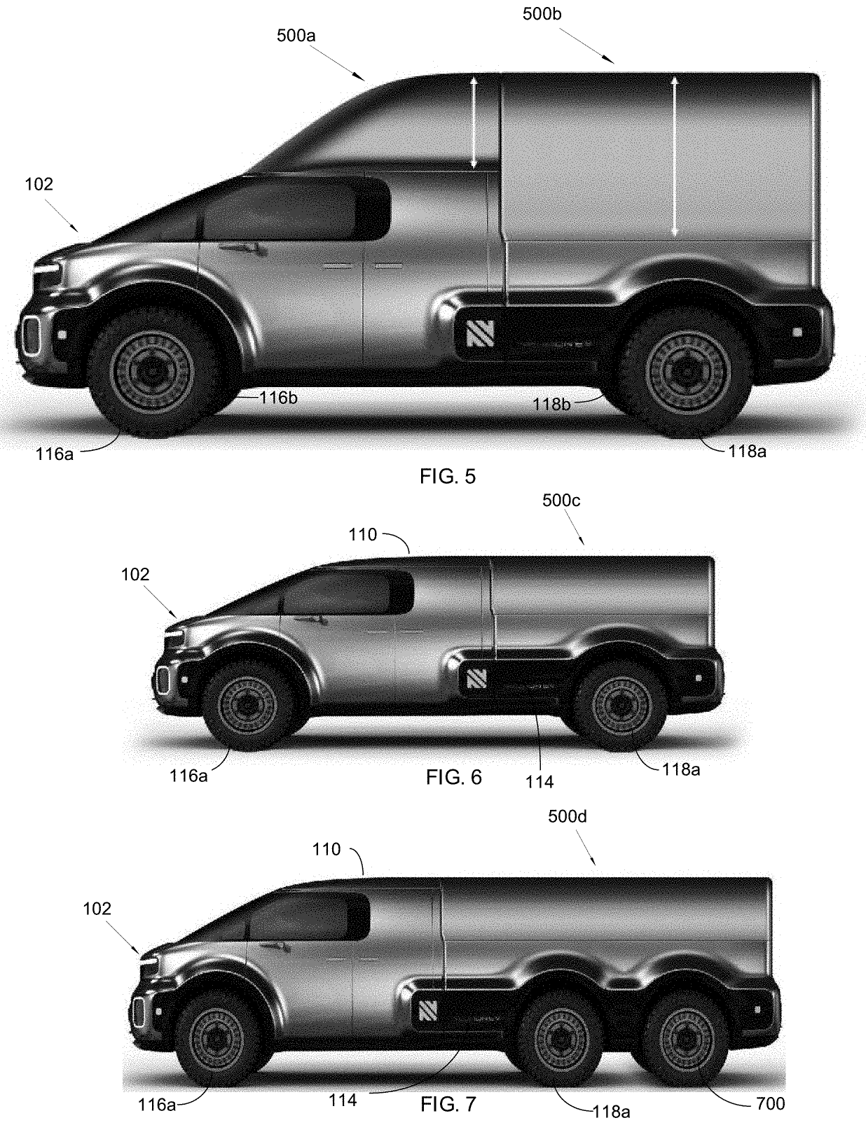

Turning now to FIGS. 5-7, the system 100 provides at least one modular body component 500a-d detachably attachable to the open truck bed 108 and/or the roof 110 of the chassis 102. The modular body component may attach to the rear portion 106 of the chassis 102 through bolts, screws, slidable rails, welding, a snap-fit relationship, or combinations thereof. In one embodiment shown in FIG. 5, the modular body component comprises a front guard 500a and a van shell 500b. The van shell 500b converts the truck into a van. In one example, a pickup truck converts to a van through a modular rear truck bed that converts the bed into an extension of enclosed interior space.

In other embodiments shown in FIG. 6, the modular body component may include a truck bed shell 500c and multiple interchangeable roofs 500b having different sizes. The use of truck bed shell 500c and interchangeable roofs creates a large pickup truck configuration that can be used to store items in the rear portion 106 safe from the elements. The roofs 500b may have different heights to accommodate the various load requirements for the open truck bed 108. FIG. 7 illustrates an elongated truck bed shell 500d that is up to 50% longer than truck bed shell 500c. The elongated truck bed shell 500d detachably mates to the sides of the open truck bed 108. Though in some embodiments, the open truck bed may be elongated to accommodate the elongated truck bed shell 500d.

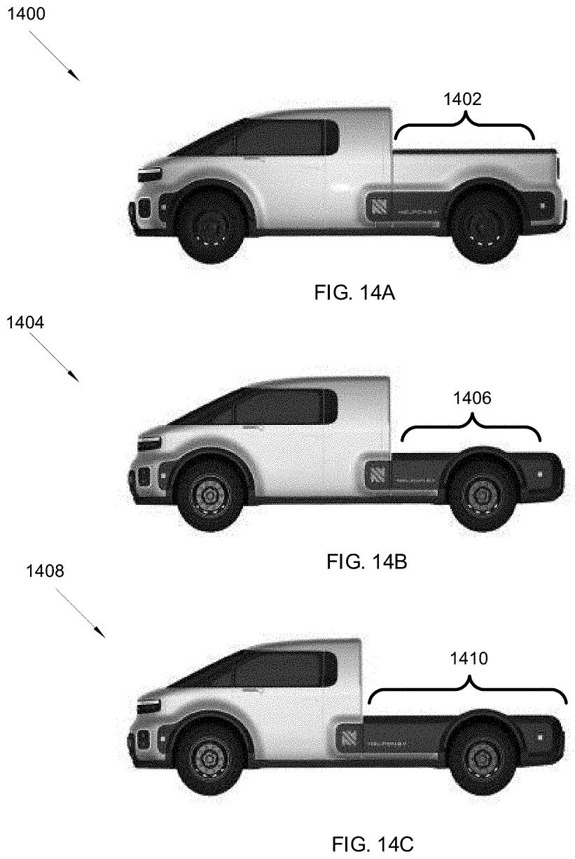

In another exemplary mode of the truck, the pickup truck converts to a semi-trailer truck. The semi-trailer conversion allows the pickup truck to remove the pickup bed, and replace with a lower rear mounting bed 1406. In this manner, the pickup truck can tow various types and sizes of trailers. For example, FIGS. 14A-14C illustrate side views of the modular electric truck system for a base model 1400, without trailers tracking the truck. FIG. 14A shows a base vehicle 1400 with a truck bed 1402 at the rear portion. In a longer version of the truck, FIG. 14B shows a base vehicle 1404 with the truck bed 1402 removed to reveal a lower rear mounting bed 1406. FIG. 14C shows the base vehicle 1406 with the rear cabin, roof, and mounting bed interchanged, so that the lower mounting bed 1410 is extendable without a wheelbase extension. Multiple additional rear wheels are added to the lower mounting bed 1410 in this configuration.

In some embodiments, the system 100 provides a pair of steerable front wheels 116a-b supporting the front portion 104 of the chassis 102. Additionally, at least two laterally spaced rear wheels 118a-b supporting the rear portion 106 of the chassis 102. In some embodiments, at least one additional wheel 700 is operational to the rear portion 106 of the chassis 102, adjacent to the rear wheels (FIG. 7). The additional wheels 700 allow for an all-wheel drive conversion of the electric truck. As illustrated, two sets of spaced-apart additional wheels 700 sit behind the rear wheels 118a-b.

Turning back to FIG. 1, the system 100 provides at least one hub motor 112a, 112b that is operational with any of the aforementioned wheels 116a-b, 118a-b, 700. The hub motor 112a, 112b may be inside the wheels. Each hub motor 112a, 112b operational to drive a respective wheel. In one embodiment, the hub motor 112a, 112bs are encompassed and operational inside the front wheels. In another embodiment, the hub motor 112a, 112b is encompassed and operational the front and rear wheels 116a-b, 118a-b, creating an all-wheel drive truck.

In some embodiments, the system 100 further comprises a regenerative electric braking circuit 214 for decelerating the electric truck 120. The regenerative electric braking circuit 214 is operatively connected to the hub motor 112a, 112b, whereby the electric braking circuit causes electric braking of the wheels. In this configuration, the hub motor 112a, 112b generates a back electromotive force that feeds the battery as a result of the braking. However in other embodiments, different braking means known in the art of automotive may also be used.

Looking now at FIG. 8, the system 100 provides at least one photovoltaic solar panel 800a-d. The photovoltaic solar panel is operatively connected to the battery 114 for recharging the battery. The solar panel charges the battery that operatively connects to the at least one hub motor 112a, 112b in the wheels 116a-b, 118a-b, 700. Those skilled in the art will recognize that photovoltaic solar panels absorb sunlight as a source of energy to generate electricity.

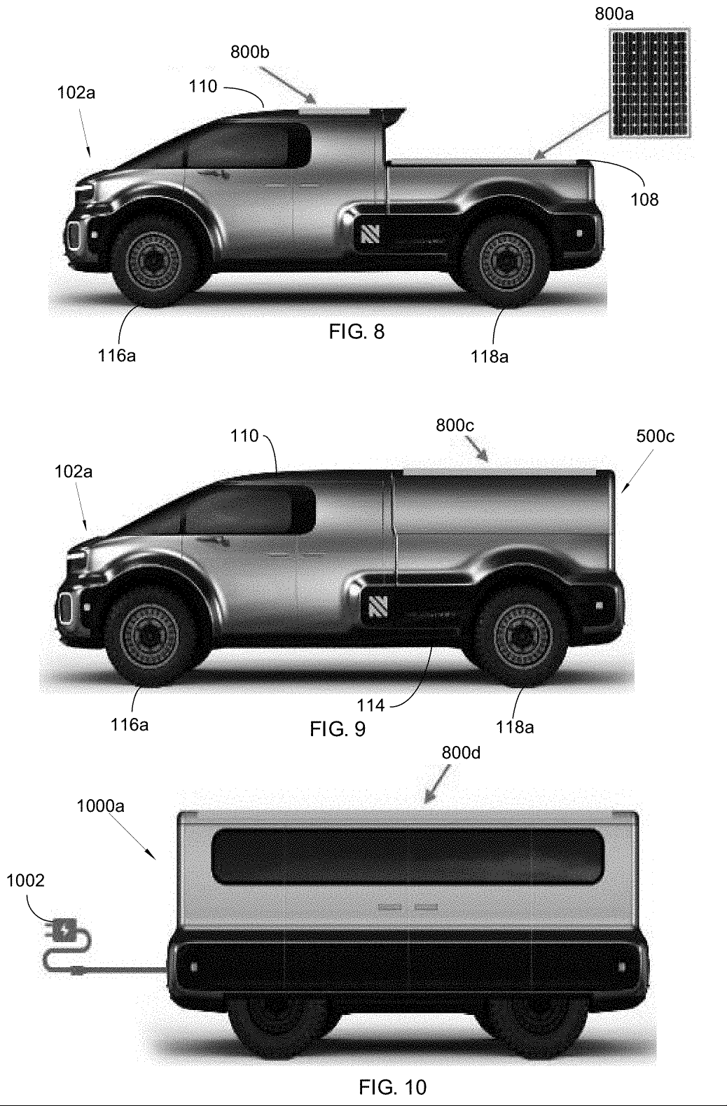

FIG. 8 references the photovoltaic solar panel 800a, 800b disposed on the open truck bed 108 and/or the roof 110 of the chassis, respectively. FIG. 9 shows a photovoltaic solar panel 800c lying along the longitudinal of the truck bed shell 500c. And FIG. 10 shows the photovoltaic solar panel 800d operational in the trailer 1000a. However it is significant to note that any combination of positions for photovoltaic solar panel 800a-d may be used on the electric truck 120 and modular body components 500a-c.

As discussed above, the electric truck 120 is electrical; and thereby a battery 114 is utilized for powering thereof. The battery 114 operatively connects to the hub motor 112a-b. Those skilled in the art will recognize that electric-vehicle batteries differ from starting, lighting, and ignition (SLI) batteries because they are designed to give power over sustained periods of time. Deep-cycle batteries are used instead of SLI batteries for the electric truck system. The battery may include, without limitation, a lead-acid battery, a nickel metal hydride, a lithium-ion battery.

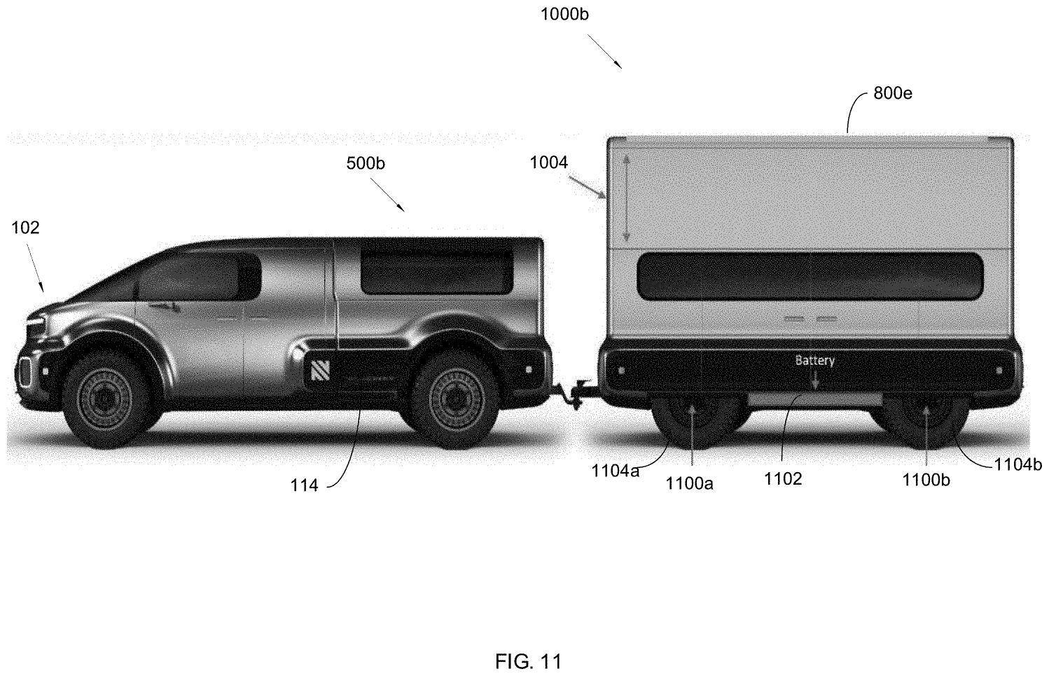

Turning now to FIG. 11, the system 100 may include at least one trailer 1000a-g that is operatively attached to the chassis 102. The trailer 1000a-g can follow the chassis 102 in a tethered, wireless, or autonomous configuration. In some embodiments, the trailer may be used to carry people, animals, and supplies. The trailer 1000a-g is adapted to receive and orient at least one of the solar panels for generating electricity for the battery 114.

In one embodiment, a tethered trailer 1000b is tethered to the rear portion of the chassis through a tether 1100, a chain, cable, or other towing mechanisms known in the art. In the tethered configuration, the trailer 1000b may be non-motorized, simply being pulled by the chassis of the electric truck. In some embodiments, multiple interchangeable trailer roofs 1004 may be used to change the dimensions and shape of the trailer, similar to the electric truck chassis 102. The interchangeable trailer roofs 1004 can have different heights and aerodynamic shapes.

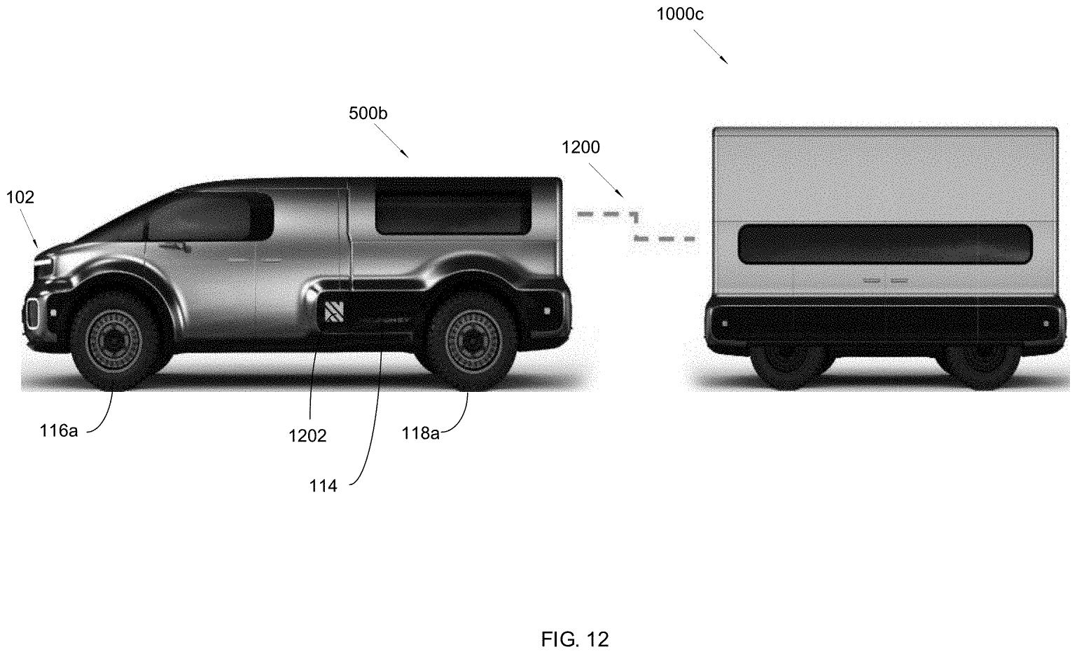

In another embodiment shown in FIG. 12, a wireless trailer 1000c is wirelessly attached to the chassis 102, and controlled with a remote control system 1200, or a remote multi-haul system. The trailer 1000c may be motorized in this wireless configuration. The remote control system 1200 is disposed in the interior cabin 200 where the driver or passenger can access it easily. However in other embodiments, the remote control system 1200 is controlled from a remote region, away from the electric truck 120.

The remote control system 1200 is configured to enable the driver, passenger, or remote user to remotely control the wireless trailer 1000c. In some embodiment, the remote control system 1200 comprises a transceiver 1202 in operational connectivity with the software program (FIG. 12). The transceiver 1202 is operable to send and receive radio frequency signals, including messages, location data, information requests, and control codes. However in other embodiments, the interior cabin 200 may have a transmitter and the trailer may have a receiver, as known in the art of remote control.

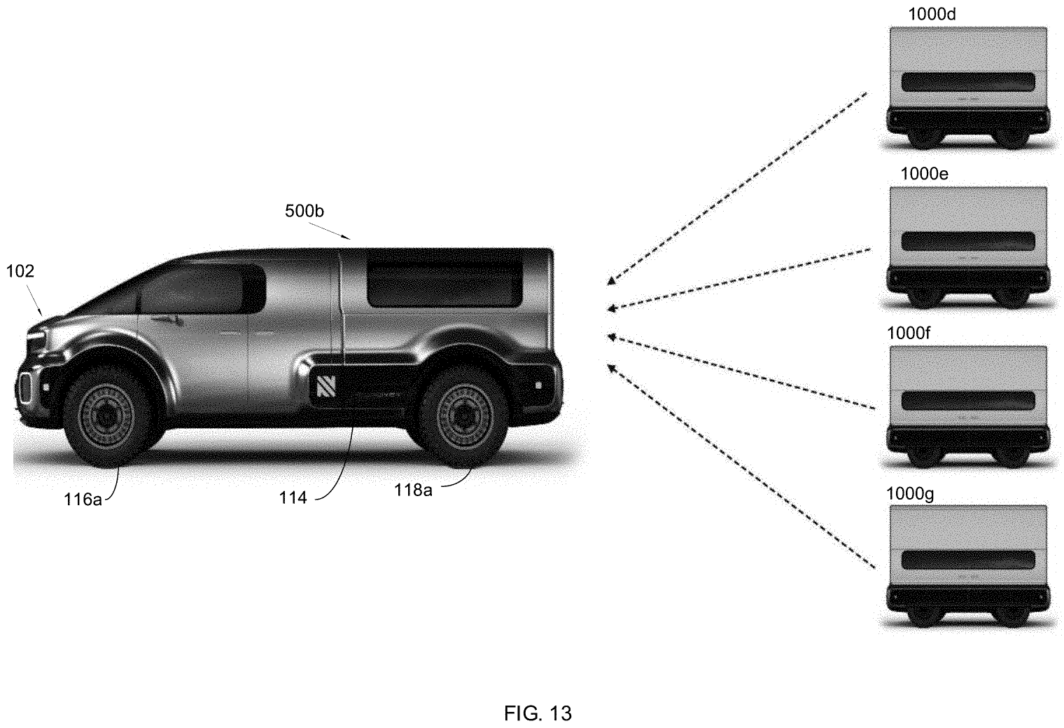

In this manner, the remote control system 1200 is operable to wirelessly control operation of the steering member 202, hub motor 112a, 112b, and brake circuit 214, so as to power and steer the trailer 1000c, such that the wireless trailer 1000c can track and follow the chassis per commands transmitted by the driver, passenger, or remote user. In yet another embodiment, multiple autonomous trailers 1000d, 1000e, 1000f, 1000g follow and track the electric truck (FIG. 13). The autonomous trailers 1000d-g may operate independently of each other, or operate in tandem.

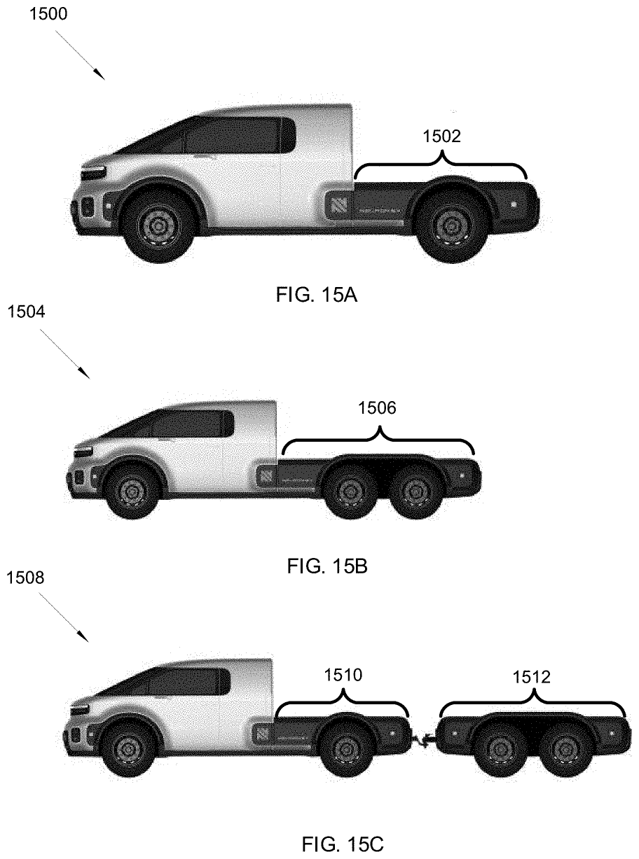

As described above, the pickup truck converts to a semi-trailer truck by removing the pickup bed, and replacing with a lower rear mounting bed 1406. In this manner, the pickup truck can tow various types and sizes of trailers. In one possible use of the semi-trailer truck conversion, FIGS. 15A-15C illustrate side view of the modular electric truck system for a semi-truck configuration of the base model. Here, FIG. 15A shows a truck 1500 with a removable truck bed 1502. Further, FIG. 15B shows the truck 1504 having a truck bed tow extension 1506. And further, FIG. 15C shows the truck 1504 having a truck bed tow extension 1506 with a detachable rear attached tow extension bed 1508 that is motorized and operable autonomously, so that the lower mounting bed is extendable without a wheelbase extension.

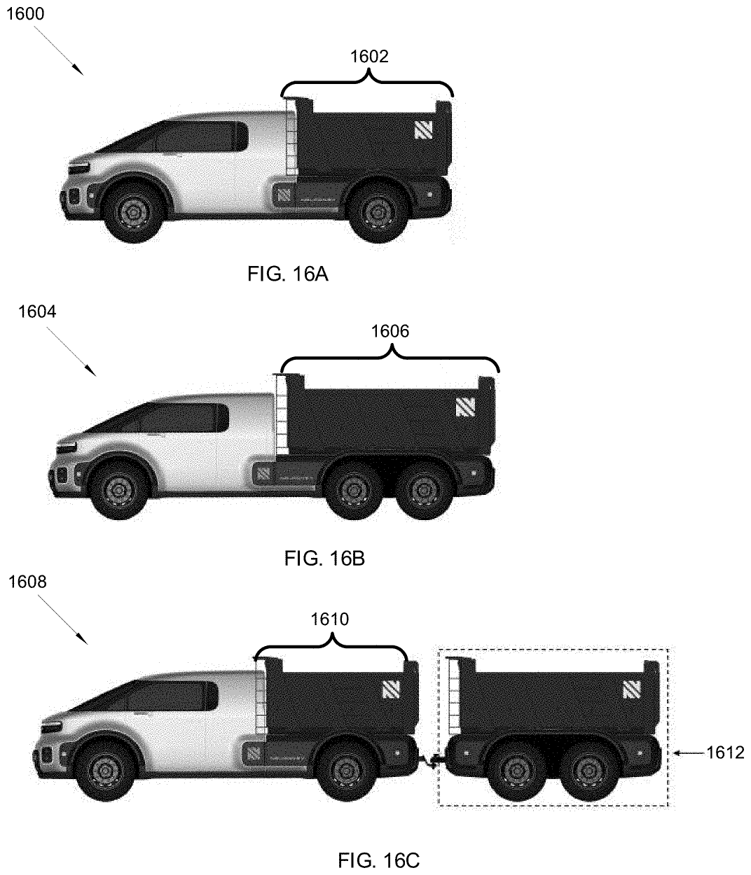

In another exemplary trailer provided in the present invention, FIG. 16A shows a semi-truck conversion truck 1600 with interchangeable and attachable open container rear compartment 1602. This may include a dump truck-style trailer for carrying waste, soil, and trash, for example. FIG. 16B shows a truck 1604 with an elongated version of the interchangeable and attachable open container rear compartment 1606. FIG. 16C shows a truck 1608 with the semi-truck conversion with interchangeable and attachable open container rear compartment 1610 and an additional detachable rear compartment 1612 that is motorized and operable autonomously.

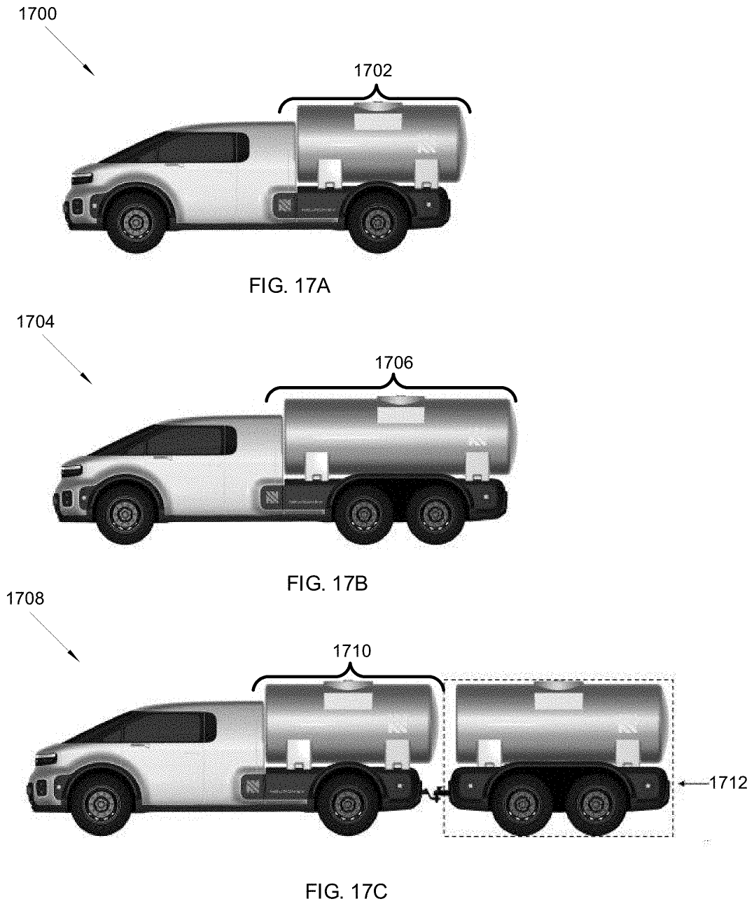

In yet another trailer-style, a vessel-style trailer for carrying liquids, milk, natural gas, and oil, can be towed behind the truck. FIGS. 17A-17C illustrate side view of the modular electric truck system for a semi-truck, where FIG. 17A shows a semi-truck 1700 with interchangeable and attachable sealed container rear compartment 1702. FIG. 17B shows the truck 1704 with an elongated version of the interchangeable and attachable sealed container rear compartment 1706. FIG. 17C shows the semi-truck 1708 with interchangeable and attachable sealed container rear compartment 1710 and an additional detachable sealed rear compartment 1712 that is motorized and operable autonomously.

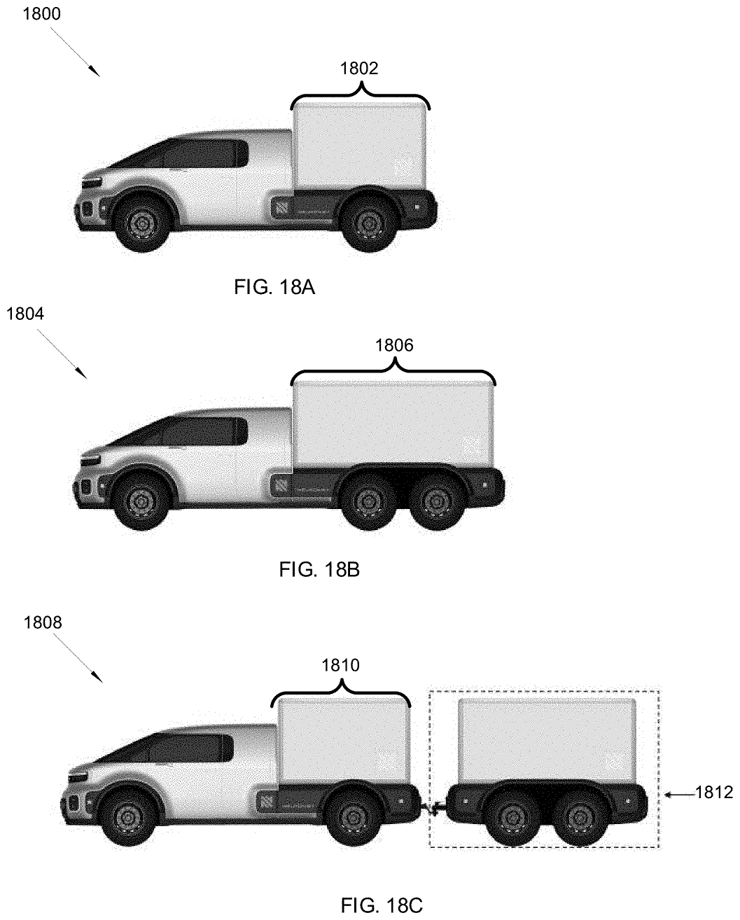

Continuing, a box car trailer can also be used. The box car trailer is configured for carrying furniture during moving, and industrial tools and materials. Thus, FIG. 18A shows a semi-truck 1800 with interchangeable and attachable container box rear compartment 1802. FIG. 18B shows the truck 1804 with an elongated version of the interchangeable and attachable container box rear compartment 1806. FIG. 18C shows the semi-truck 1808 with interchangeable and attachable container box rear compartment 1810 and an additional detachable rear compartment 1812 that is motorized and operable autonomously

In some embodiments, the software program is operational to control the autonomous trailers 1000d-g, the remote control system 1200, the illumination portion 204, the battery 114, and the hub motor 112a-b. In other embodiments, the software program enables autonomous control of the autonomous trailers 1000c-g by communicating with a processor in the trailer. The software program may utilize tracking components and software known in the art, i.e., GPS, towers, etc. The system is configurable to expand/upgrade software and hardware to integrate various technologies to support performance, safety, and convenience such as autonomous driving and have the ability to provide various functions fit for the user and/or infrastructure.

As discussed above, the system is 100% electrical, and thus, must be charged regularly. Thus, the system 100 provides a unique charging trailer 1000a that provides convenient electrical charging cable 1002 for recharging the battery 114 of the electric truck 120. The charging trailer 1000a may also be used to charge other electric vehicles that require charging. The charging trailer 1000a may operate separately from the electric truck, or may attach to the rear portion of the electric truck, charging the battery 114 while simultaneously being towed.

The trailer 1000b may have rechargeable batteries 1102 that are charged from the at least one photovoltaic solar panel 800d, 800e on the charging trailer 1000a, or one of the solar panels on the roof 110 or rear open bed 108 of the truck chassis 102. A hub motor 1100a, 1100b on each wheel 1104a, 1104b connects with the rechargeable batteries 1102 in the trailer 1000b. In yet another embodiments of the trailer 1000a, the chassis itself converts into a converted trailer. For example, a main frame of the electric truck 120 can be used to convert into the trailer. Thus, the system 100 utilizes myriad combination of trailer shapes and functions.

In some embodiments, the trailer 1000a-g may be motorized or non-motorized. The trailer 1000a-g is in a shape of a rectangular structure that can be upgraded further with autonomous technology, converting into an autonomous rectangular vehicle. The trailer 1000a-g can be used as a living space such as a home or for various outdoor activities such as camping and provides an enclosed shelter for sleep during travel. The space can be customized for various purposes such as a food truck, delivery vehicle, locker for storage/goods, merchandise pop-up store.

In conclusion, the modular electric truck system 100 provides an electric truck 120 that has a scalable chassis 102 that can be equipped with interchangeable modular body components 500a-c that detachably attach to the truck chassis to change the appearance and functionality of the electric truck. An interior cabin 200 comprises furniture, lighting elements, computer devices, and entertainment systems. The driver sits in a center driving position where visibility and positional awareness is enhanced. The electric truck is 100% electrical; and thereby provides convenient electrical charging means for the truck through a charging trailer that attaches to the truck, and/or at least one solar panel on the roof, bed, or trailer of the truck. The solar panel charges a battery that operatively connects to a hub motor in the wheels. A remote control system remotely controls at least one trailer. The trailer may be tethered, wireless, or autonomous to wirelessly track and follow the electric truck 120.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A modular electric truck system, the system comprising:
an electric truck having:
a chassis comprising a front portion defined by an interior cabin, a rear portion defined by an open truck bed, and a roof,
the interior cabin comprising a steering member, an illumination portion, at least one seat, at least one communication interface, and a computer having a software program;
at least one modular body component detachably attachable to the open truck bed of the chassis;
a pair of steerable front wheels supporting the front portion of the chassis, the front wheels operatively connected to the steering member in the interior cabin;
at least two laterally spaced rear wheels supporting the rear portion of the chassis;
at least one hub motor operational with at least one of the wheels, each hub motor operational to drive a respective wheel;
a battery operatively connected to the hub motor; and
at least one photovoltaic solar panel disposed on the roof, or the open truck bed, or the trailer, the photovoltaic solar panel being operatively connected to the battery for recharging the battery,
whereby the software program is operational to control at least one of the following: the illumination portion, the battery, and the hub motor.

2. The system of claim 1, further comprising a regenerative electric braking circuit, the regenerative electric braking circuit being operatively connected to the hub motor, whereby the regenerative electric braking circuit causes electric braking of the wheels, whereby the hub motor generates a back electromotive force that feeds the battery.

3. The system of claim 2, further comprising at least one trailer operatively attached to the chassis, the at least one trailer comprising the at least one solar panel.

4. The system of claim 3, wherein the trailer wirelessly attaches to the chassis.

5. The system of claim 4, further comprising a remote control system for controlling the hub motor, the steering member, and the regenerative electric braking circuit.

6. The system of claim 5, wherein the remote control system comprises a transceiver in operational connectivity with the software program, the transceiver being operable to send and receive radio frequency signals, including messages, location data, information requests, and control codes to and from the trailer.

7. The system of claim 6, wherein the software program enables autonomous control of the trailer.

8. The system of claim 1, wherein the trailer is tethered to the rear portion of the chassis through a tether.

9. The system of claim 1, wherein the modular body component comprises a front air guard and a van shell.

10. The system of claim 1, wherein the modular body component comprises a truck bed shell and multiple interchangeable roofs having different sizes.

11. The system of claim 1, further comprising at least one additional wheel attached to the rear portion of the chassis.

12. The system of claim 1, wherein the hub motor is encompassed inside the wheels.

13. The system of claim 1, wherein the trailer includes at least one of the following: an extended truck bed, an open container, a sealed container, and a container box.

14. A modular electric truck system, the system comprising:
an electric truck having:
a chassis comprising a front portion defined by an interior cabin, a rear portion defined by an open truck bed, and a roof,
the interior cabin comprising a steering member, an illumination portion, at least one seat, at least one communication interface, a speaker system, and a computer having a software program;
at least one modular body component detachably attachable to the open truck bed of the chassis;
a pair of steerable front wheels supporting the front portion of the chassis, the front wheels operatively connected to the steering member in the interior cabin;
at least two laterally spaced rear wheels supporting the rear portion of the chassis;
a trailer operatively attached to the chassis, the trailer comprising the at least one solar panel;
at least one hub motor operational with at least one of the wheels, each hub motor operational to drive a respective wheel;
a battery operatively connected to the hub motor;
at least one trailer operatively connected to the chassis;
a remote control system disposed in the interior cabin, the remote control system being operable to wirelessly control operation of the trailer, whereby the remote control system enables the trailer to track and follow the chassis; and
at least one photovoltaic solar panel disposed on the roof, or the open truck bed, or the trailer, the photovoltaic solar panel being operatively connected to the battery for recharging the battery,
whereby the software program is operational to control at least one of the following: the remote control system, the illumination portion, the battery, and the hub motor.

15. The system of claim 14, wherein the trailer wirelessly attaches to the chassis.

16. The system of claim 14, wherein the software program enables autonomous control of the trailer.

17. The system of claim 14, wherein the modular body component includes at least one of the following: a van shell, a truck bed shell, and multiple interchangeable roofs having different sizes.

18. The system of claim 14, further comprising at least one additional wheel attached to the rear portion of the chassis.

19. The system of claim 14, further comprising a regenerative electric braking circuit, the regenerative electric braking circuit being operatively connected to the hub motor, whereby the regenerative electric braking circuit causes electric braking of the wheels, whereby the hub motor generates a back electromotive force that feeds the battery.

20. A modular electric truck system, the system comprising:
an electric truck having:
a chassis comprising a front portion defined by an interior cabin, a rear portion defined by an open truck bed, and a roof,
the interior cabin comprising a steering member, an illumination portion, at least one seat, at least one communication interface, and a computer having a software program;
at least one modular body component detachably attachable to the open truck bed of the chassis, the at least one modular body component including at least one of the following: a front air guard, a van shell, a truck bed shell and multiple interchangeable roofs having different sizes;
a pair of steerable front wheels supporting the front portion of the chassis, the front wheels operatively connected to the steering member in the interior cabin;
at least two laterally spaced rear wheels supporting the rear portion of the chassis;
at least one additional wheel attached to the rear portion of the chassis;
a regenerative electric braking circuit operatively connected to the hub motor, the regenerative electric braking circuit causing electric braking of the wheels;
a trailer operatively attached to the chassis, the trailer comprising the at least one solar panel;
at least one hub motor operational with the wheels, the hub motor being encompassed inside the wheels, each hub motor operational to drive a respective wheel;
a battery operatively connected to the hub motor, whereby the hub motor generates a back electromotive force that feeds the battery;
at least one trailer operatively connected to the chassis;
a remote control system disposed in the interior cabin, the remote control system being operable to wirelessly control operation of the trailer, whereby the remote control system enables the trailer to track and follow the chassis; and
at least one photovoltaic solar panel disposed on the roof, or the open truck bed, or the trailer, the photovoltaic solar panel being operatively connected to the battery for recharging the battery,
whereby the software program is operational to control at least one of the following: the remote control system, the illumination portion, the battery, and the hub motor.
